(19) United States
(12) Patent Application Publication
(10) Pub. No.: US 2010/0009067 A1
(43) Pub. Date: Jan. 14, 2010

(54) PROCESS FOR PRODUCTION OF LAMINATES

(75) Inventors: Tetsuo Inoue, Osaka (JP); Toru Umemoto, Osaka (JP); Toshimasa Nishimori, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/439,292

(22) PCT Filed: Jul. 1, 2008
(86) PCT No.: PCT/JP2008/061884

§ 371 Date: Jun. 8, 2009

(30) Foreign Application Priority Data
Jul. 19, 2007 (JP) 2007-188110

(51) Int. Cl. B05D 5/12

(52) U.S. Cl. 427/66

(57) ABSTRACT

A process for producing a laminate comprises the steps of: coating a water solution containing water and a water-soluble liquid crystal compound on a surface of a substrate to form a coating film; and drying the coating film by placing the coating film in an atmosphere having 70% RH or higher to less than 100% RH to more than 10% by weight of the solvent in the coating film; wherein an optical anisotropic layer is formed on the surface of the substrate by exerting a regulating force on the water-soluble liquid crystal compound to orient the water-soluble liquid crystal compound in the drying process.

### FIELD OF THE INVENTION

The present invention relates to a process for producing a laminate having optical anisotropy, such as a polarizing film and a phase-contrast film.

### BACKGROUND OF THE INVENTION

In a liquid crystal display (LCD), a linearly polarizing plate or a circularly polarizing plate is used to control optical rotation and birefringence. Also, in an organic electroluminescent device (OLED), a circularly polarizing plate is used to avoid reflection of external light.

Conventionally, in such polarizing plates (polarizing elements), polarizing elements obtained by dissolving or adsorbing iodine or an organic dye having dichroism in a polymeric material, such as polyvinyl alcohol or the like and stretching the film in one direction to orient a dye or the like have been widely used. However, there has been a problem that conventional polarizing elements produced in such a manner are poor in heat resistance and light resistance depending on the dye or the polymeric material used. Further, a bad yield of overlapping film when producing a liquid crystal device has been raising a problem. Moreover, a film with a wide width is needed to be stretched as the display panel becomes bigger, so that an extremely large scale film forming apparatus is needed, which has become a real production problem.

Accordingly, a process for producing a polarizing film by coating a solution including a dichromatic dye on a substrate, such as a glass plate or a transparent film to form a film including the dichromatic dye and orienting the dichromatic dye utilizing a regulating force of the surface (For instance, JP 2007-61755 A and U.S. Pat. No. 2,400,877 B1) or shearing stress (For instance, JP 08-511109 A) at the time of coating has been studied.

It is a reality that polarizing films made by such known coating methods are not always good enough in performance, production stability, and easy operation.

For instance, in a method for realizing an orientation structure by shearing stress at the time of coating, it is difficult to establish a coating system for stably realizing sufficient orientation and in a conventional method for realizing an orientation structure by a regulating force, there are fears that the orientation may be poor in uniformity, resulting in a problem with production stability.

### SUMMARY OF THE INVENTION

It is an object of the present invention to provide a process for stably producing a laminate having high optical anisotropy with easy operation.

In a first preferred embodiment, a process for producing a laminate comprises the steps of: preparing a water solution containing water and a water-soluble liquid crystal compound, and a substrate; coating the water solution on a surface of the substrate to form a coating film; and drying the coating film, wherein at least a part of a drying process includes a drying process under high humidity of placing the coating film before drying in an atmosphere having 70% RH or higher to less than 100% RH and drying the coating film to remove more than 10% by weight of a solvent in the coating film, and wherein the drying process under high humidity includes the step of forming an optical anisotropic layer on a surface of the substrate by exerting a regulating force for orienting the water-soluble liquid crystal compound on the water-soluble liquid crystal compound to orient the water-soluble liquid crystal compound.

In the drying process under high humidity, the humidity of the atmosphere may be controlled so that the total drying time in the drying process under high humidity can be 300 seconds or more.

The water solution may be a solution which does not exhibit liquid crystallinity in a coating process but exhibits liquid crystallinity in the drying process under high humidity.

The concentration of the water-soluble liquid crystal compound may be 0.1 to 50% by weight.

The optical anisotropic layer may exhibit adsorption dichroism at a wavelength of 550 nm.

The surface of the substrate may have anisotropy for orienting the water-soluble liquid crystal compound.

### ADVANTAGE OF THE INVENTION

The present invention provides a process for stably producing a laminate having high optical anisotropy with easy operation.

### BRIEF DESCRIPTION OF THE DRAWING

FIG. 1 is a graph schematically illustrating changes of the concentration of a water solution as drying time lapses in the drying process under high humidity.

### DESCRIPTION OF THE PREFERRED EMBODIMENTS

A process for producing a laminate according to the present invention comprises the steps of: preparing a water solution containing water and a water-soluble liquid crystal compound, and a substrate; coating the water solution on a surface of the substrate to form a coating film; and drying the coating film, wherein at least a part of a drying process includes the drying process under high humidity of placing the coating film before drying in an atmosphere having 70% RH or higher to less than 100% RH and drying the coating film to remove more than 10% by weight of a solvent, and wherein the drying process under high humidity includes the step of forming an optical anisotropic layer on a surface of the substrate by exerting a regulating force for orienting the water-soluble liquid crystal compound on the water-soluble liquid crystal compound to orient the water-soluble liquid crystal compound.

Orientation of the water-soluble liquid crystal compound is carried out by exerting a regulating force for orienting the water-soluble liquid crystal compound on the water-soluble liquid crystal compound. The regulating force is brought by an oriented film, a magnetic field, and a shearing force or the like.

The optical anisotropic layer according to the present invention is a film having anisotropy in optical characteristics, such as adsorption and refraction. Particularly, examples of such a film include a linearly polarized film, a circularly polarized film, and a phase-contrast film. The laminate of the present invention is the most preferably used for a polarizing film.

### (Water Solution)

In a water solution used in the present invention, a water-soluble liquid crystal compound is dissolved in water. The water-soluble liquid crystal compound is also a lyotropic liquid crystal compound.

Lyotropic liquid crystallinity is a property to cause a phase transition of an isotropic phase and a liquid crystal phase according to changes of the temperature and the dye. Further, the lyotropic liquid crystal compound in the present invention is a compound exhibiting liquid crystallinity when dissolved in a specific solvent in a certain concentration range (See “Ekisho Binran (Handbook of Liquid Crystal), published by Maruzen Co., Ltd., etc.). The lyotropic liquid crystal compound is means of an oriented film, a magnetic field, a shearing force or the like, wherein molecules are oriented in a specific direction.

A water-soluble dichromatic dye is generally used as a water-soluble liquid crystal compound used in the present invention. Further, the dye is a dye having a liquid crystal phase to control orientation. The dye having a liquid crystal phase in the present invention exhibits lyotropic liquid crystallinity in the solvent and the dye exhibiting a nematic liquid-crystalline phase in a room temperature state is superior in orientation.

Examples of this liquid phase include a smectic liquid crystal phase, a cholesteric liquid crystal phase as well as a nematic liquid crystal phase. The liquid crystal phase is confirmed and identified by optical patterns observed by a polarizing microscope.

Moreover, the dichromatic dye used in the present invention is an organic compound for absorbing light at any wavelength in a wavelength range between 400 and 700 nm. And the optical anisotropic layer obtained by orientation of the dichromatic dye preferably exhibits absorption dichroism at a wavelength of 550 nm.

Specific examples of dichromatic dyes used in the present invention include azo-base dyes, anthraquinone-base dyes, perylene-base dyes, indanthrone-base dyes, imidazole-base dyes, indigoid-base dyes, oxazine-base dyes, phthalocyanine-base dyes, triphenylmethane-base dyes, pyrazolone-base dyes, stilbene-base dyes, diphenylmethane-base dyes, naphthoquinonic-base dyes, merocyanine-base dyes, quinophthalone-base dyes, xanthene-base dyes, alizarin-base dyes, acridine-base dyes, quinonimine-base dyes, thiazole-base dyes, methane-base dyes, nitro-base dyes, and nitroso-base dyes or the like. Among them, azo-base dyes, anthraquinone-base dyes, perylene-base dyes, indanthron-base dyes, and imidazole-base dyes are preferable. These dichromatic dyes may be used alone or in combination of two kinds or more. A plurality of kinds of dichromatic dyes having different absorption spectrum may be preferably combined to obtain a black colored polarizing film.

In addition, these dichromatic dyes are preferably organic compounds, including a sulfonic acid group (—SO₃H), a carboxyl group (—COOH) or their salt, a nitrogen substituted group (—NH₂, —NHR, —NR₂, —NR¹R² (R, R¹, R² are respectively a monovalent organic group)) or its salt. Among them, organic compounds including sulfonic acid group or its salt are especially preferable. Introduction of a sulfonic acid group into the dichromatic dye is effective to improve solubility into water. The greater the number of sulfonic acid group to be introduced into the dichromatic dye, the more water solubility is improved. The number of sulfonic acid group is selected as appropriate in view of solubility into water and water resistance of the optical anisotropic layer at the same time.

Further, the specific examples of dichromatic dyes used in the present invention include compounds represented by the following general formula (1).

(Chromogen) (SO₃M)ₙ General formula (1)

(wherein n is an integer 1 or more, M represents a cation).

Hydrogen ion, ion of Group I metal, such as Li, Na, K or Cs, ammonium ion or the like is preferably used as M in the general formula (1). A portion of chromogen preferably includes an azo derivative unit, an anthraquinone derivative unit, a perylene derivative unit, an imidazole derivative unit and/or an indanthrone derivative.

In a dichromatic dye (A) represented by the above-mentioned general formula (1), chromogen, such as an azo compound and a polycyclic compound structure or the like becomes a hydrophobic portion in the solution and sulfonic acid or its salt becomes a hydrophilic portion. Accordingly, the hydrophobic portion and the hydrophilic portion are collected with the balance of both portions, which leads to the exhibition of lyotropic liquid crystal as a whole.

Specific examples of an organic dye include compounds represented by the following general formulae (2) to (8):

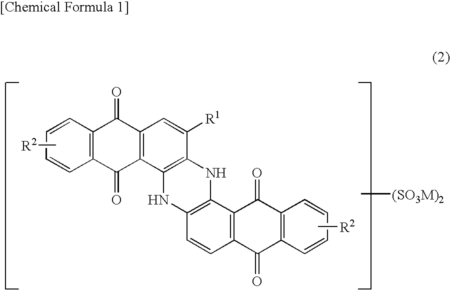

In formula (2), R¹ is hydrogen or chlorine, and R² is hydrogen, an alkyl group, ArNH or ArCONH. The alkyl group preferably has 1 to 4 carbon atoms. Especially, a methyl group or an ethyl group is preferably used as the alkyl group. A substituted or a non-substituted phenyl group is preferably used as the aryl group (Ar). Especially, a phenyl group having the fourth position replaced by chlorine is preferably used as the aryl group (Ar). Further, M is the same as the above-mentioned general formula (1).

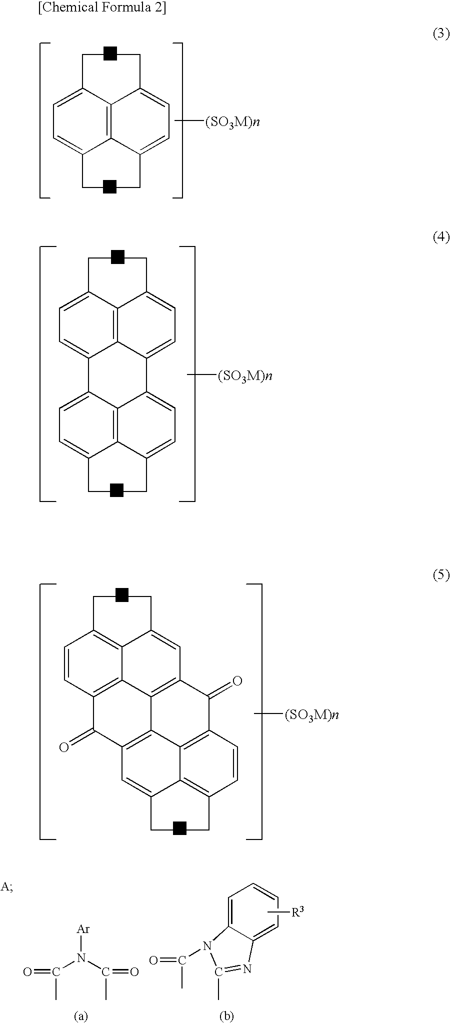

In the formulae (3) to (5), A is represented by the formula (a) or (b) in which n is equal to 2 or 3 and R³ is hydrogen, an alkyl group, a halogen or an alkoxy group, and Ar is a substituted or a non-substituted aryl group. The alkyl group preferably has 1 to 4 carbon atoms. Especially, a methyl group or an ethyl group is preferably used as the alkyl group. Bromine or chlorine is preferably used as the halogen. The alkoxy group preferably has 1 or 2 carbon atoms. Especially, the methyl group is preferably used as the alkoxy group. A substituted or a non-substituted phenyl group is preferably used as the aryl group. Especially, the non-substituted phenyl group or phenyl group having the fourth position replaced by the methoxy group, the ethoxy group, chlorine or a butyl group or the third position replaced by methyl group is preferably used as the aryl group. M is the same as the above-mentioned general formula (1)

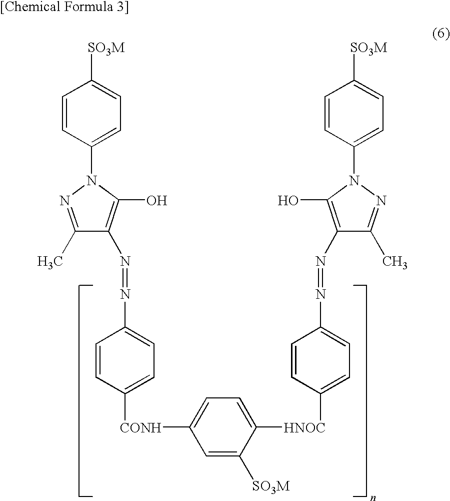

In the formula (6), n is equal to 3 to 5 and M is the same as the above-mentioned general formula (1).

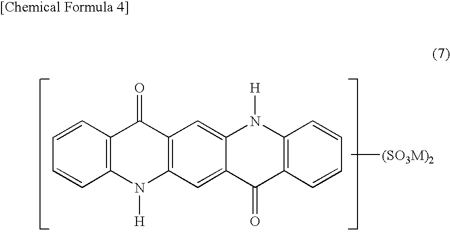

In the formula (7), M is the same as the above-mentioned formula (1).

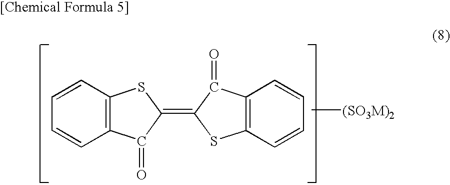

In the formula (8), M is the same as the above-mentioned general formula (1).

Introduction of a sulfonic acid group (sulfonation) into an organic compound in the above-mentioned compound includes a process for substituting the sulfonic group for hydrogen of a nucleus by allowing sulfuric acid, chlorosulfonic acid or fuming sulfuric acid to act on an organic compound. Salt in the above-mentioned compound, in which hydrogen atom dissociated with acid is substituted by monovalent ion, such as lithium ion, potassium ion, cesium ion, ammonium ion or the like.

Other specific examples of the water-soluble liquid crystal compound include dyes described in JP 2006-047966 A, JP 2005-255846 A, JP 2005-154746 A, JP 2002-090526 A, JP 08-511109 A, and JP 2004-528603 A.

Dichromatic dyes available in the market are useable as water-soluble liquid crystal compounds in the present invention. Their examples include C. I. DirectB67, DSCG (INTAL), RU31.156, Methyl orange, AH6556, Sirius Supra Blown RLL, Benzopurpurin, Copper-tetracarboxyphthalocyanine, Acid Red 266, Cyanine Dye, Violet 20, Perylenebiscarboximides, Benzopurpurin 4B, Methyleneblue (Basic Blue 9), Brilliant Yellow, Acid red 18, Acid red 27 or the like.

Electrical conductivity of water used as the solvent of water-soluble liquid crystal compounds of the present invention is preferably not more than 20 μS/cm, more preferably 0.0001 to 5 μS/cm. A polarizing film having a high dichromatic ratio may be obtained by defining the electrical conductivity of water within the above range.

Water-soluble solvents, such as an alcohol, an ether, a cellosolve, dimethylsulfooxide, dimethylformamide or the like may be added to the water solution as solvents other than water. Further, water-soluble compounds, such as glycerin, ethyleneglycol or the like may be added. These additives may be used to control solubility of the water-soluble liquid crystal compounds and the drying rate of the water solution. The additive amount of such solvents in water solution is preferably not more than 100 weight parts relative to 100 weight parts of water.

The concentration of the water solution (% by weight of the water-soluble liquid crystal compound relative to the solvent) may be controlled as appropriately so as to obtain a concentration range exhibiting liquid crystallinity in the drying process under high humidity, preferably 0.1 to 50% by weight, more preferably 1 to 40% by weight, especially preferably 1 to 30% by weight. Such concentration range of water solution allows a coating film to exhibit a stable liquid crystal state in the drying process under high humidity.

The PH of the water solution is preferably 4 to 10, more preferably 6 to 8.

Furthermore, an additive selected from a binder resin, monomer, a curing agent, a plasticizer, a surfactant, a heat stabilizer, a lubricant, an antioxidant agent, an ultraviolet absorber, a fire-retardant, an antistatic agent, a phase solubilizer, a thickener, a leveling agent, and a coupling agent or the like as necessary may be contained in water solution. The additive amount of the additive is preferably not more than 10% by weight of all water solution.

The addition of a surfactant to the water solution may improve wettability, coating property of dichromatic dyes to the surface of the substrate. Nonionic surfactant is preferably used as the surfactant. The additive amount of the surfactant is preferably not more than 5% by weight in all water solution.

### (Substrate)

A glass plate or a resin film may be used as a substrate in the present invention. The surface of the substrate preferably has anisotropy for orienting the water-soluble liquid crystal compound. Therefore, an oriented film is preferably formed on the surface by orienting treatment by rubbing. Examples of such a substrate include a substrate made by coating a polyimide film on a glass plate. Orientation property is given to the polyimide film by a known method, for example, by rubbing to a predetermined direction to form an oriented film. Known methods described in pages 226 to 239 of “Ekisho Binran (Handbook of Liquid Crystal)” (published by Maruzen Co., Ltd. on Oct. 30, 2000) may be used for orientation treatment of the substrate to control the direction of orientation of the water-soluble liquid crystal compound (dye).

Since the substrate may have flexibility when a resin film is used as the substrate, a usage required for flexibility is preferable. The surface of the resin film may be orientation treated by rubbing or the like. Alternatively, an oriented film made of other materials may be formed on the surface of the resin film.

While it is to be understood that materials of a resin film used for the substrate are not particularly limited, only if the materials are transparent resins having film forming properties, examples of the materials include stylene resin, (meta) acrylic acid resin, polyester resin, polyolefin resin, silicone resin, fluorine resin, polyimide resin, triacetylcellulose, polyvinyl alcohol resin, and polycarbonate resin.

While the thickness of the substrate is not particularly limited, the thickness is generally in the range between 1 to 1,000 μm.

### (Coating Process)

In a coating process, a water solution is coated on a surface of the substrate to form a coating film, that is, a layer thinly formed by coating the water solution on the surface of the substrate is formed. A process for coating is not particularly limited, if only it is the process for uniformly applying a coating film. Known methods, such as a rod coating method, a roll coater coating method, a flexo printing method, screen printing method, a curtain coater coating method, a spray coater coating method, and a spin coat coating method or the like may be used as appropriate.

The thickness of the coating film is preferably between 0.01 and 10 μm.

### (Drying Process)

In the drying process, the coating film is dried to remove approximately 95% or higher of the solvent in the coating film. This drying process includes the drying process under high humidity for removing 10% by weight or higher of the solvent in the coating film by placing the coating film in an atmosphere not less than 70% RH to less than 100% RH to be dried.

In the drying process under high humidity, the coating film before drying is placed in an atmosphere of not less than 70% RH to less than 100% RH to gradually remove the solvent by vaporization. Actually, the drying process is carried out by placing a substrate on which the coating film is coated in the atmosphere. The drying process may be carried out by exposing the surface of the coating film to an atmosphere of not less than 70% RH to less than 100% RH. This atmosphere is for a space part ranging from the surface of the coating film to at least 10 mm upper of the surface. The humidity is measured at the position of 10 mm from the surface of the coating film. More specifically, the atmosphere does not mean a part of humidity gradient generated by vaporization near the interface between the coating film and air.

A high-humidity atmosphere can be made, for example, by leaving at rest the coating film that is a dry target in a processing room or a chamber where inside humidity adjustments for each substrate can be made. Alternatively, that can be realized by feeding high humid air into the upper space of the coating film.

Drying the coating film can be carried out in an air-drying state without actively heating the coating film from outside. Alternatively, the coating film may be dried while actively heating or cooling.

In the present invention, the water-soluble liquid crystal compound is oriented by allowing the regulating force to act on the water-soluble liquid crystal compound in the coating film in the drying process under high humidity. The regulating force is brought, for instance, by the oriented film formed on the surface of the substrate, so that the water-soluble liquid crystal compound is oriented in parallel with or in an orthogonal with the orientation direction of the oriented film. Alternatively, the water-soluble liquid crystal compound may be oriented by exerting the regulating force generated by an electric field in a predetermined direction on the coating film using a method in accordance with the method as described in JP 05-297218 A.

The solvent is inhibited to vaporize from the coating film by placing the coating film in an atmosphere of 70% RH or higher and less than 100% RH in the drying process under high humidity, which prevents a sharp viscosity increase in the coating film. This makes it possible to keep the coating film in a liquid crystal state for a long period of time in the drying process under high humidity, so that the orientation of the water-soluble liquid crystal compound can be sufficiently carried out, taking a predetermined time and a uniform and high orientation of the water-soluble liquid crystal compound can be obtained. Further, air in this atmosphere may be in a fluidity state, but air is preferably in a static state to perform stable orientation by delaying the drying rate. When the humidity in the drying process under high humidity is 100% RH, little vaporization of the solvent in the coating film is caused, resulting in an obstacle in industrial application for the too long whole drying time. This tends to lead to trouble caused by dew formation.

On the other hand, when the coating film is transferred from the drying process under high humidity to a low humidity environment in a state in which the total amount of the solvent in the coating film removed by the drying process under high humidity is less than 10% by weight of the solvent in the coating film immediately after coating, it is impossible to keep the coating film in the state of liquid crystal for a long period of time. This makes the water-soluble liquid crystal compound impossible to obtain sufficient orientation.

The concentration of the water-soluble liquid crystal compound in the water solution is further preferably lower than the concentration that causes a concentration phase transition. In this case, a liquid crystal phase is not formed immediately after coating the water solution, so that the regulating force allows orientation to start after the concentration of the water solution rises by drying to reach over the concentration higher than the concentration that causes a concentration phase transition. In the present invention, it is possible to keep the coating film in the liquid crystal state in the process of high-humidity drying, so that very stable orientation of the water-soluble liquid crystal compound can be carried out. In addition, it is possible to improve the orientation degree.

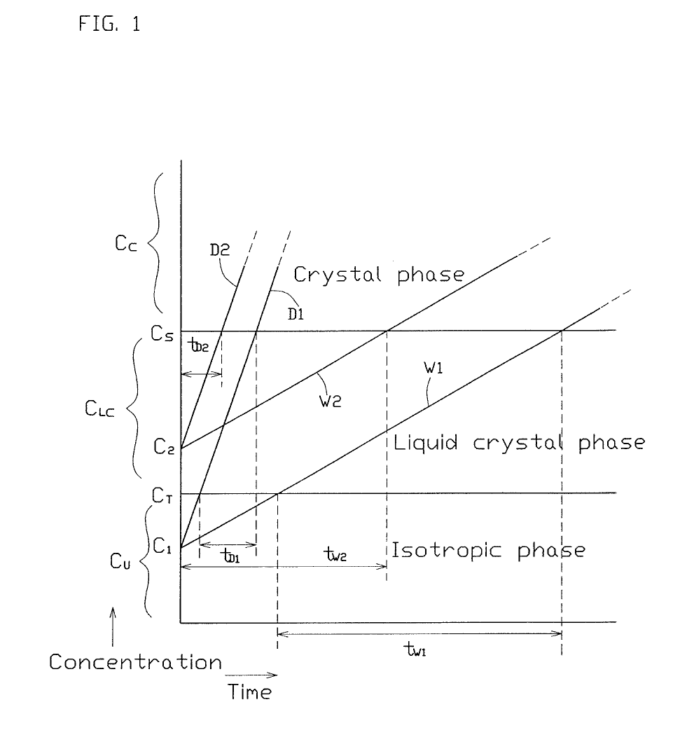

FIG. 1 schematically shows the variation per hour of the solvent concentration in a coating film in the drying process under high humidity. A transverse axis in FIG. 1 indicates elapsed time in which a time point to start the drying process under high humidity is 0 and a longitudinal axis indicates the concentration of the solvent in the coating film. Cᵤ is the concentration range of an isotropic phase, C_{LC} is the concentration range of a liquid crystal phase, and C_{c} is the concentration range of a crystal phase. C_{T} is the concentration transferred to the liquid crystal phase from the isotropic phase and Cₛ is a concentration changed from the liquid crystal phase to the crystal phase. Straight lines W1 and W2 are respectively a variation of the concentration of the solvent in the coating film per hour when placing the coating film in a predetermined atmosphere in a range of not lower than 70% RH to less than 100% RH. The straight line W1 indicates a case of the concentration C₁ being smaller than C_{T} and the straight line W2 indicates a case of the concentration C₂ in a water solution being greater than C_{T} and being smaller than C_{S}. The straight lines D1 and D2 are respectively a variation per hour of the concentration of the solvent in the coating film when placing the coating film in a predetermined atmosphere less than 70% RH. The straight line D1 indicates a case in which the concentration in the water solution is smaller than C_{T} and the straight line D2 indicates a case in which the concentration in the water solution is greater than C_{T} and smaller than C_{S}.

In a straight line W1, t_{w1} is a time zone in which the coating film is in the concentration range of the liquid crystal phase, in a straight line W2, t_{w2} is a time zone in which the coating film is in the concentration range of the liquid crystal phase, in the straight line D1, t_{D1} is a time zone in which the coating film is in the concentration range of the liquid crystal phase, and in the straight line D2, t_{D2} is a time zone in which the coating film is in the concentration range of the liquid crystal phase. As you can see from FIG. 1, t_{W1}>t_{D1}, t_{W2}>t_{D2} and t_{W1}>t_{W2}>t_{D1}>t_{D2}, unless C₂ is not close to C_{S}. Substantially, when atmospheric humidity in the straight lines W1 and W2 is 70% RH and the atmospheric humidity in the straight lines D1 and D2 is 60% RH, t_{W1}>t_{W2}>>t_{D1}>t_{D2}, unless C₂ is close to C_{S}.

Thus, the coating film can make the time zone of the liquid crystal phase in the concentration range longer by placing the coating film in the predetermined atmosphere in the range in which the humidity in the coating film is 70% RH or greater and less than 100% RH, which leads to obtain uniform and high orientation in the water-soluble liquid crystal compound.

Further, in the present invention, it is preferable that the total drying time in the drying process under high humidity is longer than 300 seconds to stably orient the water-soluble liquid crystal compound. It is further preferable that the total drying time is between 600 and 1,800 seconds to stably orient the water-soluble liquid crystal compound. The total drying time can be longer than 300 seconds by adjusting the humidity of the atmosphere to the value in the range of 70% RH or greater and less than 100% RH and setting the humidity high so that the drying rate may not be fast. In addition to that, it is possible to make the total drying time 300 seconds or more or 600 to 1,800 seconds by setting the temperature of the atmosphere or the coating film at a low temperature so that the drying rate may not be fast. The total drying time in the drying process under high humidity is time to take from placing the coating film in an atmosphere of 70% RH or greater to less than 100% RH to removing 80% by weight of the solvent or more by vaporization in the drying process under high humidity or exposing the coating film to an environment lower than 70% RH in humidity.

### (Second Drying Process)

In the present invention, a second drying process can be established after the drying process under high humidity in the drying process. The second drying process is established only if unnecessary residual solvent remains in the dried coating film in the drying process under high humidity. For instance, the entire remaining solvent or most of the remaining solvent is removed in the second drying process when 50% by weight out of the solvent contained in the coating film at the time of coating is removed by drying in the drying process under high humidity. When the entire or most of the solvent is removed by drying in the drying process under high humidity, for instance, when 95% by weight or greater out of the solvent contained in the coating film at the time of coating is removed by drying in the drying process under high humidity, the second drying process may not be needed. The second drying process is continuously carried out together with a normal drying process under high humidity. While conditions, such as humidity of the atmosphere in the second drying process or the like are not particularly limited, high temperatures and low humidity are preferable to reduce the process time. 95% by weight or greater of the solvent contained in the coating film is preferably removed by drying immediately after the completion of coating in the second drying process. That is, the second drying process is preferably carried out in the coating film dried in the drying process under high humidity when the solvent over 5% by weight of the solvent amount in the coating film immediately after coating remains.

While a laminate according to the present invention basically comprises: a substrate; and a layer of an oriented water-soluble liquid crystal compound arranged on a surface of the substrate, a further another layer may be laminated on the laminate. Fort instance, a protective layer made of a resin may be formed on the surface of the water-soluble liquid crystal compound. Alternatively, a smooth layer, a releasing layer, and an easy-binding layer may be previously formed on the surface or the back of the substrate.

The laminate according to the present invention is used for various optical elements, utilizing optical anisotropy, particularly, the laminate is favorably used as a polarizer. In this case, the dichromatic ratio of the oriented coating film is preferably 20 or greater at a wavelength of 550 nm. The dichromatic ratio is more preferably 30 or greater. The dichromatic ratio is calculated from respective transmittance of light when entering linearly polarized light in a sample (coating film) to be parallel or in an orthogonal state with the electrical field vector of the polarization of measured light with respect to an orientation direction of the coating film.

Further, the laminate according to the present invention may be used together with the substrate, but the laminate may be preferably laminated on the other support or optical elements as an oriented film after removing the coating film from the substrate.

The laminate according to the present invention is applied to various liquid crystal display apparatuses. For instance, the laminate is applied to liquid crystal apparatus, such as office automation appliances, such as personal computer monitors, laptop computers, copy machines or the like, portable devices, such as mobile phones, watches, digital cameras, Personal Digital Assistance (PDA), portable game devices or the like, home appliances, such as video cameras, television units, and microwave oven or the like, car appliances, such as rear-view mirrors, monitors for car navigation system, and car audio videos or the like, displays, such as monitors for information for stores, and security gizmos, such as supervisory monitors, care giving monitors, and monitors for medical purposes or the like.

### Example

A water solution for water-soluble perylene liquid crystal compound (made by Optiva, Inc.: Product Name “NO-15”) having SO₃H group was prepared. The concentration of the perylene liquid crystal compound with respect to the entire water solution was 5% by weight. Distilled water was used as water of the solvent. The water solution does not exhibit liquid crystallinity at a concentration of 5% by weight because the concentration (C_{T}) of the water solution to transfer from an isotopic phase to a liquid crystal phase at 23° C. was 7% by weight. The water solution was applied on a glass plate substrate having a polyimide oriented film with a slide-type coater. After carrying out rubbing treatment on the surface of the polyimide oriented film, a coating layer (coating film) of the water solution with a thickness of 5 μm is formed on the oriented film. Immediately after this, the glass plate substrate on which the coating film was formed was put into a humidified cabinet (made by Tori Han: Product Name: “WET-CABI”) at 24° C. containing humidity of 80% RH. Moisture in the coating film vaporized by 80% by weight for 20 minutes (1,200 seconds). The time zone (t_{W1}) in which a concentration range of the liquid crystal phase of the coating film was 540 seconds. And then the humidity in the humidified cabinet was gradually lowered to completely dry the coating film. The dichromatic ratio of a laminate obtained at a wavelength of 550 nm was 28.

### Comparative Example

A glass plate substrate on which a coating film obtained in such a manner as in Example 1 was formed was placed into a humidified cabinet with 55% RH. Moisture in the coating film was vaporized by 95% by weight for 3 minutes to obtain a laminate. The chromatic ratio of the laminate at a wavelength of 550 nm was 10. At this time, the time zone (t_{D1}) in which a concentration range of the liquid crystal phase of the coating film was 57 seconds.

Measurement method in Example and Comparative Example

### (Dichroism)

Linear oriented (incident light in a parallel direction or incident light in an orthogonal direction) measured light at a wavelength of 550 nm was allowed to enter V-7100 produced by JASCO Corporation so that the electric field vector of the measured light may be parallel with and orthogonal with the orientation direction of a perylene liquid crystal compound which was a sample to measure the transmittance of each light and then the dichromatic ratio was calculated by the formula:

Dichromatic ratio=(Log(1/Transmission of incident light in an orthogonal direction)/(Log(1/Transmission of incident light in a parallel direction)

### (Humidity)

Humidity was measured at a position above 10 mm from the surface of the coating layer with a thermometer (ANEMOMASTER6011).

There has thus been shown and described a novel process for production of laminates, which fulfills all the objects and advantages sought therefor. Many changes, modifications, variations, combinations and other uses and applications of the subject invention will, however, become apparent to those skilled in the art after considering this specification and the accompanying drawings which disclose the preferred embodiments thereof. All such changes, modifications, variations and other uses and applications which do not depart from the spirit or scope of the invention are deemed to be covered by the invention, which is to be limited only by the claims which follow.

1. A process for producing a laminate comprising the steps of:
preparing a water solution containing water and a water-soluble liquid crystal compound, and a substrate;
coating the water solution on a surface of the substrate to form a coating film; and
drying the coating film,
wherein at least a part of a drying process includes a drying process under high humidity of placing the coating film before drying in an atmosphere having 70% RH or higher to less than 100% RH and drying the coating film to remove more than 10% by weight of a solvent in the coating film, and wherein the drying process under high humidity includes the step of forming an optical anisotropic layer on a surface of the substrate by orienting the water-soluble liquid crystal compound.

2. The process according to claim 1, wherein the humidity of the atmosphere in the drying process under high humidity is controlled so that the total drying time in the drying process under high humidity can be 300 seconds or more.

3. The process according to claim 1 or 2, wherein the water solution is a solution which does not exhibit liquid crystallinity in a coating process but exhibits liquid crystallinity in the drying process under high humidity.

4. The process according to claim 1 or 2, wherein the concentration of the water-soluble liquid crystal compound is 0.1 to 50% by weight.

5. (canceled)

6. (canceled)

7. The process according to claim 3, wherein the concentration of the water-soluble liquid crystal compound is 0.1 to 50% by weight.

8. The process according to claim 2, wherein the optical anisotropic layer exhibits adsorption dichroism at a wavelength of 550 nm.

9. The process according to claim 3, wherein the optical anisotropic layer exhibits adsorption dichroism at a wavelength of 550 nm.

10. The process according to claim 4, wherein the optical anisotropic layer exhibits adsorption dichroism at a wavelength of 550 nm.

11. The process according to claim 7, wherein the optical anisotropic layer exhibits adsorption dichroism at a wavelength of 550 nm.

12. The process according to claim 1 or 2, wherein the surface of the substrate has anisotropy for orienting the water-soluble liquid crystal compound.

13. The process according to claim 3, wherein the surface of the substrate has anisotropy for orienting the water-soluble liquid crystal compound.

14. The process according to claim 4, wherein the surface of the substrate has anisotropy for orienting the water-soluble liquid crystal compound.

15. The process according to claim 7, wherein the surface of the substrate has anisotropy for orienting the water-soluble liquid crystal compound.

16. The process according to claim 8, wherein the surface of the substrate has anisotropy for orienting the water-soluble liquid crystal compound.

17. The process according to claim 9, wherein the surface of the substrate has anisotropy for orienting the water-soluble liquid crystal compound.

18. The process according to claim 10, wherein the surface of the substrate has anisotropy for orienting the water-soluble liquid crystal compound.

19. The process according to claim 11, wherein the surface of the substrate has anisotropy for orienting the water-soluble liquid crystal compound.
